(19) United States
(12) Patent Application Publication
(10) Pub. No.: US 2024/0295645 A1
(43) Pub. Date: Sep. 5, 2024

(54) BACKING LAYER OF ULTRASONIC PROBE

(71) Applicants: Pierre BELANGER, Montreal (CA); Sévan BOUCHY, Montréal (CA); Ricardo ZEDNIK, Houston, TX (US)

(72) Inventors: Pierre BELANGER, Montreal (CA); Sévan BOUCHY, Montréal (CA); Ricardo ZEDNIK, Houston, TX (US)

(21) Appl. No.: 18/475,557

(22) PCT Filed: Sep. 20, 2022
(86) PCT No.: PCT/CA2022/051385

§ 371 Date: Sep. 27, 2023

Related U.S. Application Data
(60) Provisional application No. 63/247,864, filed on Sep. 24, 2021.

(51) Int. Cl. G01S 7/521; C04B 14/34; C04B 28/06; C04B 103/32; C04B 111/00; C04B 111/28

(52) U.S. Cl. CPC G01S 7/521; C04B 14/34; C04B 28/06; C04B 2103/32; C04B 2111/00991; C04B 2111/28; C04B 2201/30

(57) ABSTRACT

It is provided a backing layer material resistant to temperature of up to about 600° C. comprising stainless steel powder, cement, water, and optionally at least one adjuvant, a ultrasonic transducer comprising said backing layer material conferring stability to the a ultrasonic transducer to temperature of up to about 600° C.

### CROSS-REFERENCE TO RELATED APPLICATION

The present application is claiming priority from U.S. Provisional Application No. 63/247,864 filed Sep. 24, 2022, the content of which is hereby incorporated by reference in its entirety.

### TECHNICAL FIELD

The present disclosure relates generally to ultrasonic transducers and, more particularly, to a compact probe comprising a backing layer material that can operate at 650° C.

### BACKGROUND

Ultrasonic transducers are used in a wide variety of contexts including, but not limited to, oil and gas applications, nuclear plants, and in the medical field. Ultrasonic transducers are essentially outputting an ultrasonic pulse or vibration in a direction of an object or area to be sensed. The echoes of the original ultrasonic pulse reflected off the object or another point in the sensor range are detected. Ultrasonic transducers typically include a piezoelectric element, positioned between two electrodes, designed to generate the ultrasonic pulse when a voltage is applied across the electrodes. The piezoelectric element may also move in response to the ultrasonic echoes reaching the transducer, and this movement can generate a voltage across the electrodes that is used to determine a distance from the transducer to the sensed object. Ultrasonic transducers typically also include a backing material positioned above the piezoelectric element to reduce reverberations inside the transducer.

A waveguide (metal rod of several tens of centimeters) is also used to move the probe away from areas heaters. Generally as ultrasonic transducers are used in environments of high temperature, air or water coolers are needed to keep the piezoelectric element at a low temperature.

Still further, as temperature rises, the effects on the materials typically used in known transducers can reduce the capability of dampening the reverberations from the piezoelectric element via the backing material. There can also be significant changes in the attenuation coefficient of the backing material as the transducers gets softer at higher temperatures. Consequently, for example when oil and gas plant processes attain very high temperature, the plant need to be stopped to allow detection by ultrasonic transducers causing delays in time and lost in profitability as the plant needs to be restarted. There are currently ultrasonic probes that are bulky and/or comprise a cooling system which lead to failures and are not efficient. In consequence, the maximum continuous operating temperature of some commercial probes is much less than 600° C.

There is thus a need to be provided with ultrasonic transducers that can operate at very high temperatures.

### SUMMARY

It is provided a backing layer material resistant to temperature of up to about 600° C., preferably 650° C., comprising stainless steel powder, cement, water, and optionally at least one adjuvant.

In an embodiment, the stainless steel powder has an average bead size between 5 and 100 μm.

In a further embodiment, the stainless steel powder has an average bead size between 20 to 50 μm.

In another embodiment, the stainless steel powder is at least one of a ceramic powder, 17-4PH stainless steel, 304 stainless steel and 316 stainless steel.

In a further embodiment, the cement comprises a high alumina content.

In an embodiment, the cement is at least one of a calcium aluminate cement (CAC), a molten cement and a refractory cement.

In a particular embodiment, the cement is SECAR® 71.

In a further embodiment, the material comprises less than 2% by weight of cement of the total weight of the material.

In another embodiment, the material comprises at least one adjuvant consisting of a superplasticizer.

In an embodiment, the superplasticizer is Master Genium 7,500 or Plastol 5,700.

It is also provided an ultrasonic transducer comprising a piezoelectric element, a pair of electrodes disposed one on each side of the piezoelectric element to enable a current flow through the piezoelectric element, and a backing layer material as defined herein, disposed on one side of the piezoelectric element to attenuate vibrations in the ultrasonic transducer from the piezoelectric element, wherein the backing element material renders the ultrasonic transducer stable at temperatures of up to about 600° C.

In another embodiment, the ultrasonic transducer further comprises a bonding material disposed between the backing layer material and the piezoelectric element to bond the backing layer material to the piezoelectric element.

In an embodiment, it also provided a system comprising the ultrasonic transducer as described herein and a control component, wherein the control component is coupled to the ultrasonic transducer by a pair of wires coupled to each electrodes and the backing element material renders the ultrasonic transducer stable at temperatures of up to about 600° C. The system can also comprise a thermocouple embedded in the backing layer.

It is also provided a method of preparing a backing layer material resistant to temperature of up to about 600° C. comprising the steps of mixing powdered steel, cement and water in humid conditions forming a mixture, heating the mixture to remove any moisture by raising firstly gradually the temperature below the boiling point and subsequently raising said temperature, and cooling the mixture to obtain the backing layer material.

In an embodiment, the temperature is raised to about 540° C. at the rate of 150° C./h.

In another embodiment, the mixture is heated gradually to about 93° C. and maintained for 6 hours.

In a further embodiment, the temperature is raised to about 540° C. at the rate of 150° C./h and maintained for 6 hours.

In an embodiment, the powdered steel, cement and water are mixed in a humid chamber and the mixture is cured in said humid chamber.

In a further embodiment, the powdered steel, cement and water are mixed in a proportion of 12:2:1 respectively.

In another embodiment, the mixture is cured for 28 days.

### BRIEF DESCRIPTION OF THE DRAWINGS

Reference will now be made to the accompanying drawings.

FIG. 1 illustrates a sectional view of an ultrasonic transducer showing all the materials and their arrangement with respect to each other in accordance to an embodiment.

FIG. 2 illustrates a sectional view of an example of a resulting ultrasonic probe prepared as described herein.

It will be noted that throughout the appended drawings, like features are identified by like reference numerals.

### DETAILED DESCRIPTION

It is provided a backing layer material that is incorporated into a ultrasonic transducer resistant to temperature of up to 650° C.

It is described a material for an absorption, bottom or back layer of a transducer that contains cement, powdered steel, water with or without a superplasticizer. Accordingly, a method of applying a base material is described involving pouring the mixture into a molding vessel containing a layer of piezoelectric material, degas the mixture and harden it until the mixture is reaching its final properties. The element is disposed on one side of the piezoelectric element to dampen vibrations in the ultrasonic transducer from the piezoelectric element. As described herein, the resulting ultrasonic transducer is stable at temperatures up to 650° C. and above, and there is no need of a cooling system.

The material provided can serve as an absorption layer in an ultrasonic probe operating at temperatures below or to about 650° C. This material has an acoustic impedance close to piezoelectric element order to allow the transmission of waves in this layer. The material also has sufficient absorption to damp the waves traveling through it.

The compact probe provided herewith allows continuous monitoring of installations operating at high temperature and can be moved into tight spaces.

Thus as encompassed herein, it is provided an ultrasonic transducer comprising a piezoelectric element, a pair of electrodes disposed one on each side of the piezoelectric element to enable a current flow through the piezoelectric element, and a backing layer material as described herein, disposed on one side of the piezoelectric element to attenuate vibrations in the ultrasonic transducer from the piezoelectric element, wherein the backing element material renders the ultrasonic transducer stable at temperatures of up to 600° C.

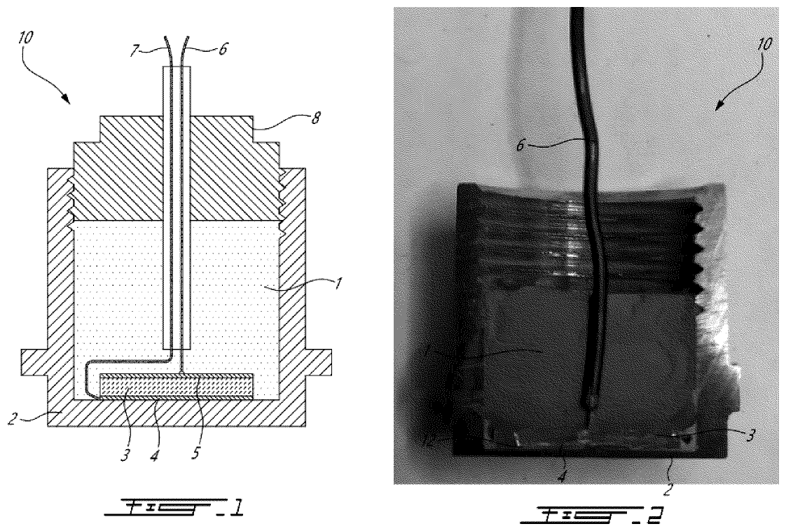

As depicted in FIG. 1, the ultrasonic transducer or probe 10 provided comprises a backing layer 1 present in a surrounding case and matching layer 2. The backing layer 1 is disposed on one side of a piezoelectric element 3 to attenuate vibrations in the ultrasonic transducer from the piezoelectric element. Electrodes (4, 5) are disposed one on each side of the piezoelectric element 3 to enable a current flow through the piezoelectric element 3.

Each of the electrodes (4, 5) may be coupled to one of a pair of leads or wires (6, 7) that are generally routed away from the ultrasonic transducer 10 through a connector or cap 8. These leads (6, 7) may be used to communicatively couple the ultrasonic transducer 10 to a control component (e.g., wireline device, slickline device, drill string, or work string) or other component within which the transducer is incorporated. Accordingly, also encompassed is a system comprising the ultrasonic transducer described herein and a control component, wherein the control component is coupled to the ultrasonic transducer by a pair of wires coupled to each electrodes. The backing element material renders the ultrasonic transducer stable at temperatures of up to 600° C.

The backing layer 1 is used to recover the waves of the piezoelectric crystal 3 (acoustic impedance equal to that of the crystal) and attenuate the waves (coefficient sound attenuation) that do not go to the item to be inspected. It provides a means to add a mass on the crystal 3 to widen its bandwidth and have more precision on the signal. Given the high temperature, the thermal expansion coefficients must be taken into account.

The backing layer 1 encompassed herein comprises (i) stainless steel powders, (ii) cements, (iii) water (distilled water or running water); and optionally (iv) at least one superplasticizer.

The stainless steel powders encompassed herein have an average bead size between 5 and 100 μm. In an embodiment, the stainless steel powders have an average bead size in the range 20 to 50 μm. In an embodiment, but not limited to, high density ceramic powders is encompassed. In an embodiment, the current powders used are 17-4PH, 304 and 316 stainless steel. The resistance to basicity of the concrete (pH approx. 13) is an important consideration and the high temperature of 600° C. prevent the use of conventional steel for example. Thermal expansion coefficients also eliminates tungsten (3 vs. 12 μm/m/° C.).

Additionally, cements used can be for example cements with a high alumina content, e.g. CAC (Calcium aluminate cement), molten cement or refractory cements (eg: SECAR® 71). Concrete has better resistance because there are fewer pores, greater compactness. Having less pores decreases the sound attenuation coefficient. A rule of thumb is to add by weight of admixtures 0.6% of the weight of the cement and to have less than 2% by weight of the total.

In an embodiment, the backing layer 1 comprises at least one superplasticizer such as Master Genium 7,500 and Plastol 5,700 (euclid chemical). The addition of an adjuvant such as a superplasticizer allows to reduce the amount of water which needs to be incorporated, resulting in an increase in density of the backing layer.

In an embodiment, a mix is made at a percentage ratio by weight of powdered steel, cement and water and it is possible to adjust the ratios to vary the acoustic properties of the mixture (acoustic impedance and acoustic attenuation) depending on the piezoelectric crystal (here lithium niobate LiNbO³). The cementitious mixture needs to stay wet in order to harden. Each day, the properties evolve and increase depending on the day of drying, depending on the desired properties. Even after several days at room temperature, this mixture contains residual moisture. This residual moisture must be removed, as using concrete above the melting point of water (100° C.) will cause vapor build-up which will cause cracks. In order to remove residual moisture, the temperature is gradually raised to 93° C. (below the boiling point) and this temperature can be maintained for 6 hours. The temperature can then be raised if necessary to 540° C. This cycle can be repeated if necessary.

The resulting backing layer is used to from a ultrasonic transducer 10 as exemplified in FIG. 2, which also comprises a bonding material 12 disposed between the backing material 1 and the piezoelectric element 3 to bond the backing material to the piezoelectric element 3, wherein the bonding material 12 can comprise ceramic powder or metal powder disposed therein.

The tests carried out to characterize the concrete present in the backing layer must follow the CSA standard which recommends the application of a load (N) on a unit area (mm²). The compressive strength is expressed in MPa. It is measured on a cylindrical sample of 100 mm×200 or 150×300 mm. It can be measured at 3 days, 7 days, 21 days, 28 days, and/or 56 days. The reference value is at 28 days. The CSA standard recommends 3 samples including 1 to 7 days and 2 to 28 days.

Ultrasonic probes described herein are capable of operating at high temperature are intended for industries such as e.g. petroleum, nuclear, metallurgical and mining. The probes could be installed long term for residual thickness measurements and defects detection.

While the present disclosure has been described with particular reference to the illustrated embodiment, it will be understood that numerous modifications thereto will appear to those skilled in the art. Further, the present disclosure has been described in connection with specific embodiments thereof, it will be understood that it is capable of further modifications and this application is intended to cover any variations, uses, or adaptations and including such departures from the present disclosure as come within known or customary practice within the art and as may be applied to the essential features hereinbefore set forth, and as follows in the scope of the appended claims.

1-10. (canceled)

11. An ultrasonic transducer comprising:
a piezoelectric element;
a pair of electrodes deposited one on each side or on the same side of the piezoelectric element to enable a current flow through the piezoelectric element; and
a backing layer material comprising at least one of stainless steel powder, cement, and water, said backing layer material disposed on one side of the piezoelectric element to attenuate vibrations in the ultrasonic transducer from the piezoelectric element, wherein the backing element material renders the ultrasonic transducer stable at temperatures of up to about 600° C.

12. The ultrasonic transducer of claim 11, wherein the stainless steel powder has an average bead size between 5 and 100 μm.

13: A system comprising the ultrasonic transducer of 11 and a control component, wherein the control component is coupled to the ultrasonic transducer by a pair of wires coupled to each electrodes and the backing element material renders the ultrasonic transducer stable at temperatures of up to about 600° C.

14: The ultrasonic transducer of claim 1, wherein the backing layer material is prepared by mixing powdered steel, cement and water.

15. (canceled)

16: The ultrasonic transducer of claim 14, wherein the powdered steel, cement and water are mixed in a proportion of 10:2:1 respectively.

17: The method of claim 14, wherein the mixture is cured in 3 days or more.

18: The method of claim 14, wherein the mixture is heated gradually to 93° C. and maintained for 6 hours.

19: The method of claim 14, wherein the temperature is raised to about 540° C. at the rate of 2.5° C./min to remove water.

20. (canceled)

21: The ultrasonic transducer of claim 1, further comprising a bonding material present between the backing layer material and the piezoelectric element to bond the backing layer material to the piezoelectric element.

22: The ultrasonic transducer of claim 1, wherein the cement comprises a high alumina content.

23: The ultrasonic transducer of claim 22, wherein the cement is at least one of a calcium aluminate cement (CAC), a molten cement and a refractory cement.

24: The ultrasonic transducer of claim 1, wherein the cement is SECAR® 71.

25: The ultrasonic transducer of claim 1, comprising 20-30% by weight of cement of the total weight of the material.

26: The ultrasonic transducer of claim 1, wherein the material comprises at least one adjuvant consisting of a superplasticizer.

27: The ultrasonic transducer of claim 26, comprising less than 5% by weight the adjuvant of the total weight of the material.

28: The ultrasonic transducer of claim 27, wherein the superplasticizer is Master Genium 7,500 or Plastol 5,700.

29: The ultrasonic transducer of claim 1, wherein the stainless steel powder has a high coefficient thermal expansion.

30: The ultrasonic transducer of claim 29, wherein the stainless steel powder has a coefficient thermal expansion of between 9 to 17 μm/m/° C.

31: The ultrasonic transducer of claim 1, wherein the backing layer material is prepared by further curing the mixture in humid conditions, heating the mixture to remove any moisture by raising firstly gradually the temperature below the boiling point and subsequently raising said temperature, and cooling the mixture to obtain the backing layer material.
